(19) United States
(12) Patent Application Publication
(10) Pub. No.: US 2026/0095917 A1
(43) Pub. Date: Apr. 2, 2026

(54) REFERENCE LOCATIONS FOR BEAMS

(71) Applicant: Lenovo (United States) Inc., Morrisville, NC (US)

(72) Inventors: Sher Ali Cheema, Ilmenau (DE); Ahmed Hindy, Aurora, IL (US)

(73) Assignee: Lenovo (United States) Inc., Morrisville, NC (US)

(21) Appl. No.: 18/905,035

(22) Filed: Oct. 2, 2024

(51) Int. Cl. H04W 72/23; H04W 64/00; H04W 72/044; H04W 74/0833

(52) U.S. Cl. CPC H04W 72/23; H04W 64/00; H04W 72/046; H04W 74/0833

(57) ABSTRACT

Various aspects of the present disclosure relate to reference locations for beams. An apparatus, such as a UE, receives a first downlink beam and transmits at least one uplink signal based at least in part on the first downlink beam, the at least one uplink signal mapped to a reference location. The UE receives a second downlink beam, wherein one or more spatial characteristics of the second downlink beam are based at least in part on the first downlink beam and the reference location associated with the at least one uplink signal.

### TECHNICAL FIELD

The present disclosure relates to wireless communications, and more specifically to beam management (e.g., identification, selection, refinement) in wireless communications.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, that transmit and/or receive signaling.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may include a UE for wireless communication to receive a first downlink beam; transmit at least one uplink signal based at least in part on the first downlink beam, the at least one uplink signal mapped to a reference location; and receive a second downlink beam, wherein one or more spatial characteristics of the second downlink beam are based at least in part on the first downlink beam and the reference location associated with the at least one uplink signal.

In some implementations of the method and apparatuses for a UE described herein, the at least one uplink signal corresponds to a physical random access channel (PRACH); the at least one uplink signal is part of a set of uplink signals, and each uplink signal of the set of uplink signals is mapped to a different respective reference location; the second downlink beam includes one or more of demodulation reference signal (DMRS) for physical downlink shared channel (PDSCH), TRS, or channel state information reference signal (CSI-RS); one or more of a coverage area, a beam width, or a beam footprint associated with the first downlink beam is larger than one or more of a coverage area, a beam width, or a beam footprint associated with the second downlink beam; the at least one uplink signal includes a PRACH based on a mapping relation of a set of reference locations corresponding to the first downlink beam according to a random access channel (RACH) procedure, and wherein the PRACH is transmitted over a RACH occasion (RO) of a corresponding synchronization signal block (SSB); the mapping relation of the set of reference locations to ROs of an SSB index is based at least in part on one-to-one mapping of the set of reference locations to the ROs in an ascending order of a configuration.

In some implementations of the method and apparatuses for a UE described herein, the mapping relation of the set of reference locations to ROs of an SSB index is based at least in part on a set of distinct preambles corresponding to each reference location of the set of reference locations; the at least one processor is configured to cause the UE to receive a configuration for the uplink signal, wherein the configuration includes an indication to transmit PRACH based on a mapping of reference locations to ROs of an SSB in a connected state; the configuration for the uplink signal includes a validity duration of the set of reference locations; the at least one uplink signal includes two uplink signals each associated with a different reference location; the at least one processor is configured to cause the UE to transmit the two uplink signals based at least in part on a difference in a distance of the UE from a first reference location and distance of the UE from a second reference location satisfies a threshold; the at least one processor is configured to cause the UE to transmit the at least one uplink signal using a spatial filter associated with the first downlink beam.

In some implementations of the method and apparatuses for a UE described herein, the at least one processor is configured to cause the UE to receive non-terrestrial network (NTN) system information block (SIB) including mapping information for a set of reference locations with at least one SSB; the set of reference locations corresponding to the first downlink beam are configured as a set of latitude and longitude; the set of reference locations corresponding to the first downlink beam are configured as a set of position state vectors; the at least one uplink signal includes a sounding reference signal (SRS) based on a mapping relation of a set of reference locations corresponding to the first downlink beam, and wherein the SRS is transmitted over time and frequency resources corresponding to the set of reference locations of an SSB; information about at least one reference location from a set of configured reference locations of the first downlink beam is transmitted as part of uplink control information (UCI).

Some implementations of the method and apparatuses described herein may further include a processor for wireless communication to receive a first downlink beam; transmit at least one uplink signal based at least in part on the first downlink beam, the at least one uplink signal mapped to a reference location; and receive a second downlink beam, wherein one or more spatial characteristics of the second downlink beam are based at least in part on the first downlink beam and the reference location associated with the at least one uplink signal.

Some implementations of the method and apparatuses described herein may further include a method performed by a UE, the method including receiving a first downlink beam; transmitting at least one uplink signal based at least in part on the first downlink beam, the at least one uplink signal mapped to a reference location; and receiving a second downlink beam, wherein one or more spatial characteristics of the second downlink beam are based at least in part on the first downlink beam and the reference location associated with the at least one uplink signal.

In some implementations of the method and apparatuses for a UE described herein, the method further comprising where the at least one uplink signal corresponds to a PRACH; the at least one uplink signal is part of a set of uplink signals, and each uplink signal of the set of uplink signals is mapped to a different respective reference location; the second downlink beam includes one or more of DMRS for PDSCH, TRS, or CSI-RS; one or more of a coverage area, a beam width, or a beam footprint associated with the first downlink beam is larger than one or more of a coverage area, a beam width, or a beam footprint associated with the second downlink beam; the at least one uplink signal includes a PRACH based on a mapping relation of a set of reference locations corresponding to the first downlink beam according to a RACH procedure, and wherein the PRACH is transmitted over a RO of a corresponding SSB; the mapping relation of the set of reference locations to ROs of an SSB index is based at least in part on one-to-one mapping of the set of reference locations to the ROs in an ascending order of a configuration.

In some implementations of the method and apparatuses described herein, the method further comprising where the mapping relation of the set of reference locations to ROs of an SSB index is based at least in part on a set of distinct preambles corresponding to each reference location of the set of reference locations; In some aspects, the techniques described herein relate to a method, further including receiving a configuration for the at least one uplink signal, wherein the configuration includes an indication to transmit PRACH based on a mapping of reference locations to ROs of an SSB in a connected state; a configuration for the at least one uplink signal includes a validity duration of the set of reference locations; the at least one uplink signal includes two uplink signals each associated with a different reference location; further including transmitting the two uplink signals based at least in part on a difference in a distance of the UE from a first reference location and distance of the UE from a second reference location satisfies a threshold.

In some implementations of the method and apparatuses described herein, the method further comprising transmitting the at least one uplink signal using a spatial filter associated with the first downlink beam; further including receiving NTN SIB including mapping information for a set of reference locations with at least one SSB; a set of reference locations corresponding to the first downlink beam are configured as a set of latitude and longitude; a set of reference locations corresponding to the first downlink beam are configured as a set of position state vectors; the at least one uplink signal includes a SRS based on a mapping relation of a set of reference locations corresponding to the first downlink beam, and wherein the SRS is transmitted over time and frequency resources corresponding to the set of reference locations of an SSB; information about at least one reference location from a set of configured reference locations of the first downlink beam is transmitted as part of UCI.

Some implementations of the method and apparatuses described herein may further include a NE for wireless communication to transmit a first downlink beam; receive at least one uplink signal based at least in part on the first downlink beam, the at least one uplink signal mapped to a reference location; and transmit a second downlink beam, wherein one or more spatial characteristics of the second downlink beam are based at least in part on the first downlink beam and the reference location associated with the at least one uplink signal.

In some implementations of the method and apparatuses described herein, the at least one uplink signal includes PRACH; the at least one uplink signal is part of a set of uplink signals, and each uplink signal of the set of uplink signals is mapped to a different respective reference location; the second downlink beam includes one or more of DMRS for PDSCH, TRS, or CSI-RS; one or more of a coverage area, a beam width, or a beam footprint associated with the first downlink beam is larger than one or more of a coverage area, a beam width, or a beam footprint associated with the second downlink beam; the at least one uplink signal includes a PRACH based on a message 2 transmission according to a RACH procedure, and wherein the PRACH is received over a RACH occasion of a corresponding SSB; the at least one uplink signal includes two uplink signals each associated with a different reference location.

Some implementations of the method and apparatuses described herein may further include a method performed by a NE, the method including transmitting a first downlink beam; receiving at least one uplink signal based at least in part on the first downlink beam, the at least one uplink signal mapped to a reference location; and transmitting a second downlink beam, wherein one or more spatial characteristics of the second downlink beam are based at least in part on the first downlink beam and the reference location associated with the at least one uplink signal.

In some implementations of the method and apparatuses described herein, the method further comprising where the at least one uplink signal includes PRACH; the at least one uplink signal is part of a set of uplink signals, and each uplink signal of the set of uplink signals is mapped to a different respective reference location; the second downlink beam includes one or more of DMRS for PDSCH, TRS, or CSI-RS; one or more of a coverage area, a beam width, or a beam footprint associated with the first downlink beam is larger than one or more of a coverage area, a beam width, or a beam footprint associated with the second downlink beam; the at least one uplink signal includes a PRACH based on a message 2 transmission according to a RACH procedure, and wherein the PRACH is received over a RACH occasion of a corresponding SSB; the at least one uplink signal includes two uplink signals each associated with a different reference location.

### BRIEF DESCRIPTION OF THE DRAWINGS

FIG. 1 illustrates an example of a wireless communications system in accordance with aspects of the present disclosure.

FIG. 2 and FIG. 3 illustrate cell mapping scenarios in an non-terrestrial network (NTN).

FIG. 4 illustrates Frequency Reuse Factor (FRF) scenarios in an NTN.

FIG. 5 illustrates an example implementation scenario where multiple beams are in a cell and each beam is mapped to a bandwidth part (BWP).

FIG. 6 illustrates a scenario for reference locations for beams in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of a NE in accordance with aspects of the present disclosure.

FIG. 10 illustrates a flowchart of a method in accordance with aspects of the present disclosure.

FIG. 11 illustrates a flowchart of a method in accordance with aspects of the present disclosure.

### DETAILED DESCRIPTION

In a wireless communications system, a UE and a NE (e.g., a base station, gNB) may support wireless communication (e.g., reception and/or transmission of wireless communication) using time-frequency resources. As part of improving usage of time-frequency resources, beam management assists in improving signal directivity to increase coverage and capacity. In NTN deployments, satellites are several hundred to several thousand kilometers away from ground UEs, and hence the role of beamforming becomes more critical. For instance, the number of beams spanning the coverage area is significantly larger than terrestrial network (TN) deployments, and hence the power consumed on beam management as well as the beam acquisition time is significantly larger. This issue becomes more critical as new low-cost non-geostationary orbit (NGSO) satellites are power limited as compared to TN-based stations, and thus distributing the limited satellite on-board power to a large number of beams can reduce the link budget significantly. Furthermore, for a NGSO system, the beam dwelling time (e.g., the time over which the strongest beam per UE is expected to change) is short, leading to the need for beam update procedures.

Aspects of the present disclosure are described in the context of a wireless communications system, and include implementations that provide solutions for an enhanced beam refinement framework (e.g., for NTN deployments) that enables switching from wider beams to narrower beams (e.g., via a single operation) with the help of location assistance information within the wider beam footprint. For instance, a set of beams is grouped into a plurality of beam groups according to at least one of an activation behavior and deactivation behavior of a beam, and uplink (UL) and downlink (DL) signaling is provided to enable refining a beam in the set of beams to a narrower beam for DL dedicated signaling to improve performance. A location assisted initial access mechanism is also described to identify a best suitable narrow beam for Msg2 transmission, where RACH transmission can be based on a mapping relation of a set of reference locations to the RACH resources of an SSB. A location assisted beam refinement method in connected mode is also described, where wider beam to narrower beam switching is assisted by the UE. For instance, the UE can transmit at least one uplink signal based on a reference location in the wider beam and using the wider beam spatial filter.

By performing the described techniques, a device in a wireless communications system can achieve enhanced DL signal coverage. The enhanced DL coverage, for example, can occur in initial access procedures where the network may transmit Msg2 in a narrow beam.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

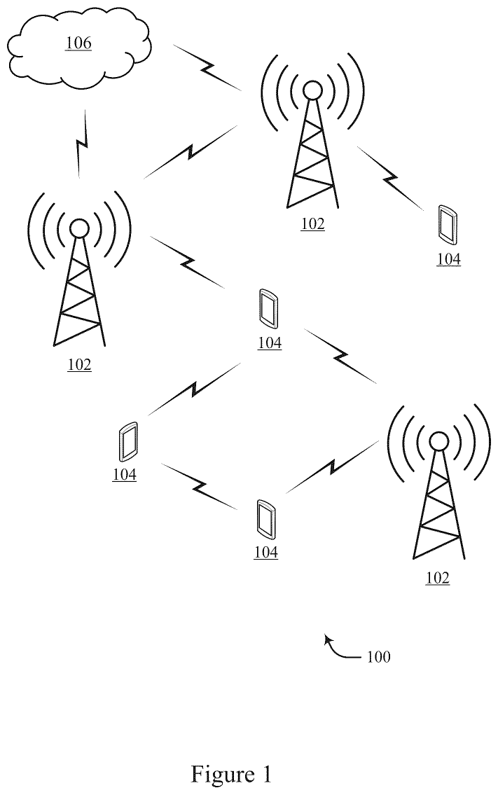

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with an NTN. In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 millisecond (ms) duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=⁰, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 receives (e.g., obtains, retrieves) a first downlink beam (e.g., first downlink beamformed transmission) and transmits at least one uplink signal (e.g., uplink transmission) based at least in part on the first downlink beam, the at least one uplink signal mapped to a reference location. The UE receives (e.g., obtains, retrieves) a second downlink beam (e.g., second downlink beamformed transmission), wherein one or more spatial characteristics of the second downlink beam are based at least in part on the first downlink beam and the reference location associated with the at least one uplink signal.

An NE 102 (e.g., a satellite, a base station, gNB) transmits (e.g., sends, communicates signals, outputs) a first downlink beam (e.g., first downlink beamformed transmission) and receives (e.g., obtains, retrieves) at least one uplink signal (e.g., uplink transmission) based at least in part on the first downlink beam, the at least one uplink signal mapped to a reference location. The NE 102 transmits (e.g., sends, communicates signals, outputs) a second downlink beam (e.g., second downlink beamformed transmission), wherein one or more spatial characteristics of the second downlink beam are based at least in part on the first downlink beam and the reference location associated with the at least one uplink signal. In implementations, the term “transmission” can refer to a signal that is not steered and is transmitted or received on a resource mapped to a downlink and/or uplink direction in a downlink and/or uplink phase. In contrast, a “beamformed transmission” can refer to a signal transmitted over a beam that is directed in a specific direction.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

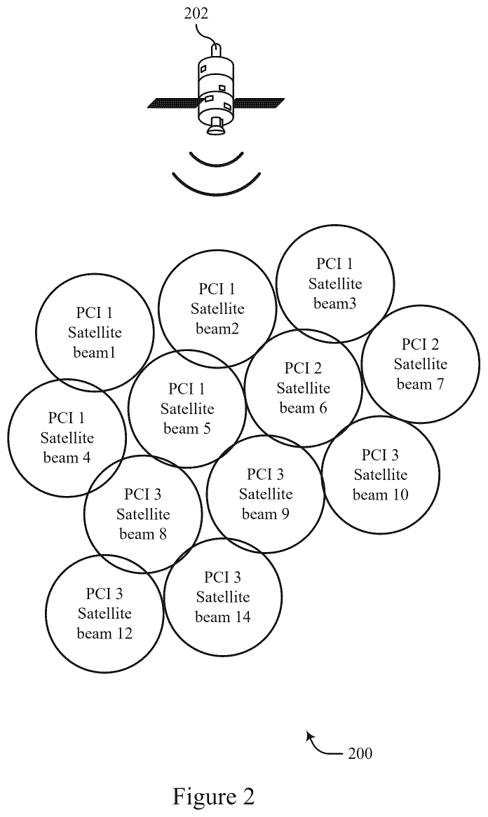

FIG. 2 illustrates a cell mapping scenario 200 in an NTN. In the example of FIG. 2, a satellite 202 may be configured to or operable to support a set of beams (also referred to as satellite beams) for wireless communication (e.g., for downlink and/or uplink communication). For example, a beam may carry one or more synchronization signal blocks (SSBs). In some cases, a beam may be referred to as an SSB beam. Each SSB can be transmitted and received in a specific direction using a beam. Multiple beams may be used by the satellite 202 to cover different coverage areas. The satellite 202 may be an example of NE as described herein. One or more subset of beams of the set of beams of the satellite 202 may be associated with a same cell (i.e., a same physical cell identity (PCI) for each beam of the subset of beams). For example, a first satellite beam may be associated with a first PCI (PCI 1), a second satellite beam may be associated with the PCI 1, a third satellite beam may be associated with the PCI 1, a fourth satellite beam may be associated with the PCI 1, a fifth satellite beam may be associated with the PCI 1. Additionally, or alternatively, a sixth satellite beam may be associated with a second PCI (PCI 2) and a seventh satellite beam may be associated with the PCI 2. Additionally, or alternatively, an eighth satellite beam may be associated with a third PCI (PCI 3), a nineth satellite beam may be associated with the PCI 3, a tenth satellite beam may be associated with the PCI 3, an eleventh satellite beam may be associated with the PCI 3, a thirteenth satellite beam may be associated with the PCI 3, and a fourteenth satellite beam may be associated with the PCI 3. It should be understood that the numbering of PCI provided herein is exemplary and for illustrative purposes.

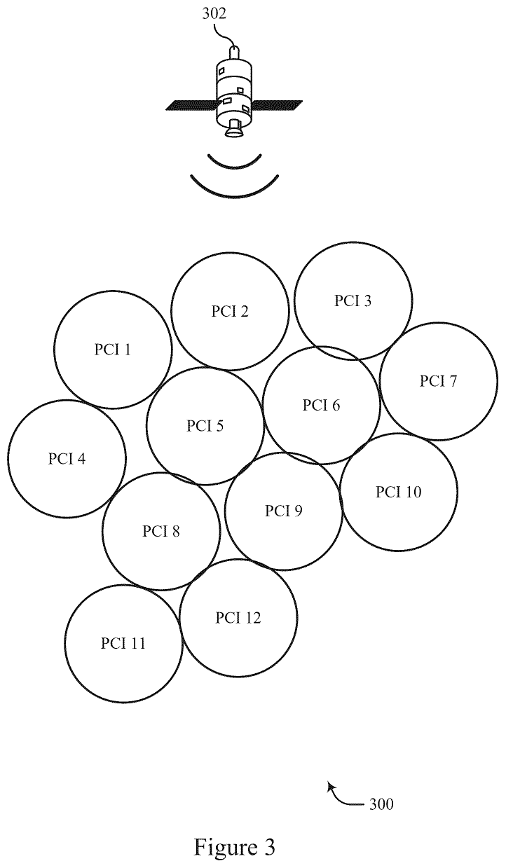

FIG. 3 illustrates a cell mapping scenario 300 in an NTN. A satellite 302 may be configured to or operable to support a set of beams (also referred to as satellite beams) for wireless communication (e.g., for downlink and/or uplink communication). For example, a beam may carry one or more SSBs. In some cases, a beam may be referred to as an SSB beam. Each SSB can be transmitted and received in a specific direction using a beam. Multiple beams may be used by the satellite 302 to cover different coverage areas. The satellite 302 may be an example of NE as described herein. In the example of FIG. 3, each beam may be a cell (e.g., a geographic coverage area of the satellite 302) and each beam may be associated with a respective PCI (i.e., different PCI). For example, a first satellite beam may be associated with a first PCI (PCI 1), a second satellite beam may be associated with a second PCI (PCI 2), a third satellite beam may be associated with a third PCI (PCI 3), a fourth satellite beam may be associated with a fourth PCI (PCI 4), a fifth satellite beam may be associated with a fifth PCI (PCI 5), a sixth satellite beam may be associated with a sixth PCI (PCI 6), a seventh satellite beam may be associated with a seventh PCI (PCI 7), an eighth satellite beam may be associated with an eighth PCI (PCI 8), a nineth satellite beam may be associated with a nineth PCI (PCI 9), a tenth satellite beam may be associated with a tenth PCI (PCI 10), an eleventh satellite beam may be associated with an eleventh PCI (PCI 11), and twelfth satellite beam may be associated with a twelfth PCI (PCI 12). It should be understood that the numbering of PCI provided herein is exemplary and for illustrative purposes.

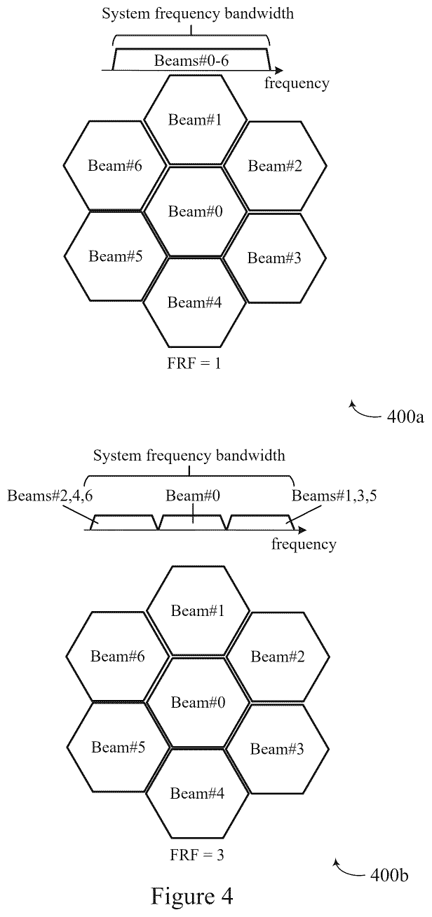

FIG. 4 illustrates FRF scenarios in an NTN. In the example of FIG. 4, scenario 400a illustrates an example where an FRF is equal to one (FRF=1) (also referred to as FR-1 scheme), while scenario 400b illustrates an example where the FRF is equal to three (FRF=3) (also referred to as FR-3 scheme). In some cases, frequency reuse schemes (FRF>1) have been proposed to mitigate inter-cell/beam co-channel interference. Spatial frequency reuse techniques improve the signal-to-interference-and-noise ratio (SINR) but can inherently limit the per-beam bandwidth and the system capacity. For instance, in the scenario 400a, beams 0-6 share the same carrier frequency and bandwidth of the available system bandwidth. In the example of scenario 400b, the FRF-3 scheme offers a protection against inter-cell interference. However, only a third of the spectral resources are used within each cell, as shown in the scenario 400b. For instance, in the scenario 400b, beams 2, 4, 6 are allocated a first BWP of the available system bandwidth (e.g., spectral resources), beam 0 is allocated a second BWP of the available system bandwidth, and beams 1, 3, 5 are allocated a third BWP of the available system bandwidth. NTN system level simulations have shown potential gains for the FRF-3 scheme over the FRF-1 scheme.

In scenarios of operation with one beam per cell, lower layer (also referred to as Layer-1 (L1)), such as physical (PHY) layer behavior can be less complex although more higher layer procedures (also referred to as Layer-2 (L2) and/or Layer-3 (L3)), such as RRC layer, medium access control (MAC) layer, radio link control (RLC) layer, etc. are required due to frequent handover, especially for Low Earth Orbit (LEO). In scenarios of operation with multiple beams per cell, L1 beam management as described in 3GPP Release 15 can be reused frequently. In scenarios of FRF greater than 1 (FRF>1), the concept of using BWPs to enable a frequency reuse was discussed in 3GPP Release 16. It was proposed that mapping different BWPs to different parts of a system bandwidth and different beams might allow L1-based mobility within a large cell (e.g., coverage area). Specifically, for a flexible frequency reuse, a beam-specific BWP can be configured. The objective would be to replace the component carrier which is not as flexible as a BWP. The same component carrier can be used on all cells (e.g., FR-1), but each beam would be assigned a beam-specific BWP. For the configuration of beam-specific BWPs in NTN, the same configuration parameters can be used, including starting position, size, and the subcarrier spacing. However, an indication of the associated beam is to be added: a beam-index (CSI-RS associated with the beam).

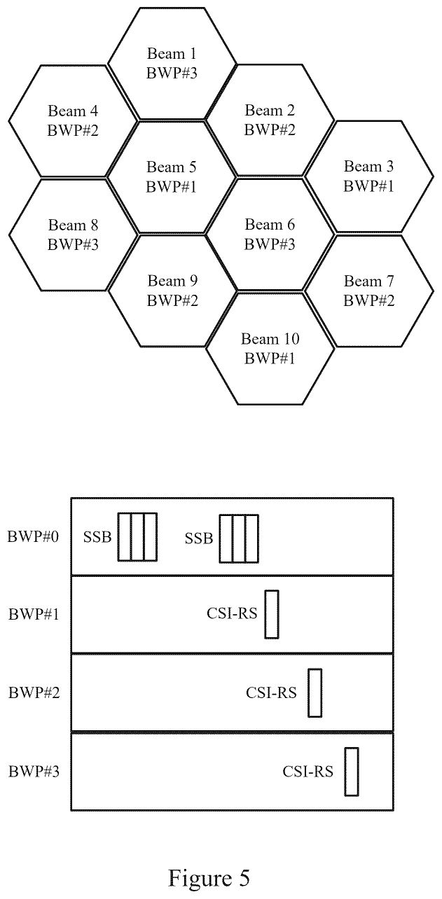

FIG. 5 illustrates an example scenario 500 where multiple beams are in a cell and each beam is mapped to a BWP. The scenario 500, for instance, represents an implementation where FRF is equal to 3 (FR-3). In legacy NR specifications, a device first needs to switch from initial BWP #0 to the serving BWP #x. Similarly, in the scenario 500, SSBs via all beams 1-10 within the cell are transmitted on BWP #0. Further, beams 3, 5, 10 are allocated BWP #1, beams 2, 4, 7, 9 are allocated BWP #2, and beams 1, 6, 8 are allocated BWP #3. The UE performs Downlink (DL) synchronization and Random Access Channel (RACH) procedure on BWP #0. After RRC connected, the BWP corresponding to the detected SSB can be configured to the UE as an active BWP (e.g., RRC-configured BWP). This involves that the satellite can transmit the SSB on BWP #0 in addition to transmit Physical Downlink Control Channel (PDCCH)/PDSCH on the associated BWP. For instance, BWP #0 can be used for initial cell access with all beams corresponding to SSB indices. For connected UE, the active BWP #1, #2, or #3 can be used with several beams. Assuming a device makes measurements and transmits CSI-RS on a BWP that is different from the BWP of the current serving satellite beam, the device will need to retune its carrier frequency for measurements and perform frequency compensation to report measurements frequently via CSI-RS, e.g., every 10 seconds typically in LEO scenario with earth-moving beams.

The following discusses antenna panel/port, quasi-collocation, Transmission Configuration Indication (TCI) state, and spatial relation. In some implementations, the terms antenna, panel, and antenna panel are used interchangeably. An antenna panel may be a hardware that is used for transmitting and/or receiving radio signals at frequencies lower than 6 GHz, e.g., frequency range 1 (FR1), or higher than 6 GHz, e.g., frequency range 2 (FR2) or millimeter wave (mmWave). In some implementations, an antenna panel may comprise an array of antenna elements, where each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some implementations, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information may be communicated via signaling or, in some implementations, capability information may be provided to devices without a need for signaling. In the case that such information is available to other devices, it can be used for signaling or local decision making.

In some implementations, a device (e.g., UE, node) antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (LNA) power consumption associated with the antenna elements or antenna ports).

The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some implementations, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to gNB. For certain condition(s), gNB or network can assume the mapping between device's physical antennas to the logical entity “device panel” may not be changed. For example, the condition may include until the next update or report from device or comprise a duration of time over which the gNB assumes there will be no change to the mapping. A Device may report its capability with respect to the “device panel” to the gNB or network. The device capability may include at least the number of “device panels”. In one implementation, the device may support UL transmission from one beam within a panel; with multiple panels, more than one beam (one beam per panel) may be used for UL transmission. In another implementation, more than one beam per panel may be supported/used for UL transmission.

In some of the implementations described, an antenna port is defined such that the channel over which a symbol on the antenna port is conveyed can be inferred from the channel over which another symbol on the same antenna port is conveyed.

Two antenna ports are said to be Quasi Co-Location (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, qcl-Type may take one of the following values:

- ‘QCL-TypeA’: {Doppler shift, Doppler spread, average delay, delay spread}
- ‘QCL-TypeB’: {Doppler shift, Doppler spread}
- ‘QCL-TypeC’: {Doppler shift, average delay}
- ‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation etc.

QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission, e.g. the UE would need to form beams for directional transmission. A QCL-TypeD between two reference signals A and B, the reference signal A is considered to be spatially co-located with reference signal B and the UE may assume that the reference signals A and B can be received with the same spatial filter (e.g., with the same receive beamforming weights).

An “antenna port” according to an implementation may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the implementations described, a TCI state associated with a target transmission can indicate parameters for configuring a quasi-collocation relationship between the target transmission (e.g., target reference signal of Demodulation (DM)-RS ports of the target transmission during a transmission occasion) and a source reference signal(s) (e.g., SSB/CSI-RS/Sounding Reference Signal (SRS)) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the implementations described, a TCI state comprises at least one source reference signal to provide a reference (UE assumption) for determining QCL and/or spatial filter.

In some of the implementations described, a spatial relation information associated with a target transmission can indicate parameters for configuring a spatial setting between the target transmission and a reference signal (e.g., SSB/CSI-RS/SRS). For example, the device may transmit the target transmission with the same spatial domain filter used for reception the reference signal (e.g., DL reference signal such as SSB/CSI-RS). In another example, the device may transmit the target transmission with the same spatial domain transmission filter used for the transmission of the reference signal (e.g., UL reference signal such as SRS). A device can receive a configuration of a plurality of spatial relation information configurations for a serving cell for transmissions on the serving cell.

In some of the implementations described, a UL TCI state is provided if a device is configured with separate DL/UL TCI by RRC signaling. The UL TCI state may comprise a source reference signal which provides a reference for determining UL spatial domain transmission filter for the UL transmission (e.g., dynamic-grant/configured-grant based physical uplink shared channel (PUSCH), dedicated physical uplink control channel (PUCCH) resources) in a component carrier (CC) or across a set of configured CCs/BWPs.

In some of the implementations described, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference signal used for determining both the DL QCL information and the UL spatial transmission filter. The source reference signal determined from the indicated joint (or common) TCI state provides QCL Type-D indication (e.g., for device-dedicated PDCCH/PDSCH) and is used to determine UL spatial transmission filter (e.g., for UE-dedicated PUSCH/PUCCH) for a CC or across a set of configured CCs/BWPs. In one example, the UL spatial transmission filter is derived from the reference signal of DL QCL Type D in the joint TCI state. The spatial setting of the UL transmission may be according to the spatial relation with a reference to the source reference signal configured with qcl-Type set to ‘typeD’ in the joint TCI state.

In the discussion herein: (1) the following notions can be used interchangeably: network nodes, transmit-receive point (TRP), panel, set of antennas, set of antenna ports, uniform linear array, cell, node, radio head, communication (e.g., signals/channels) associated with a control resource set (CORESET) pool, communication associated with a TCI state from a transmission configuration comprising at least two TCI states; (2) A Tracking Reference Signal (TRS) can correspond to an non-zero power (NZP) CSI-RS resource set with a parameter ‘trs-info’ being configured; (3) A CSI-RS for beam management may correspond to CSI-RS associated with an NZP CSI-RS resource set with a parameter ‘repetition’ being configured; (4) A CSI-RS for CSI can correspond to an NZP CSI-RS resource set with neither parameters ‘trs-info’ nor ‘repetition’ being configured; (5) A matrix can imply a sequence of fields of an arbitrary dimension, including an array (vector) of values, a standard 2D matrix and more generally a Q-dimensional matrix (tensor) wherein Q>2 is an integer value; (6) The notions CSI report setting, CSI report configuration, CSI reporting configuration can be used interchangeably to represent the same notion; (7) A CSI framework or procedure associated with up to 3GPP Rel-18 can be referred to as legacy behavior; (8) A beam may correspond to at least one of an NZP CSI-RS transmitted over a CSI-RS resource, or an SSB signal. Various implementations are described herein and one or more elements or features from one or more of the described implementations may be combined. Configuration and reporting aspects discussed herein may be applied for various NTN scenarios, e.g., when one beam corresponds to one cell or when multiple beams are configured within a cell. Configuration and reporting aspects discussed herein may be applied to various cell NTN cell layout configurations, e.g., earth-fixed cells, quasi earth-fixed cells, earth moving cells, etc.

Implementations described herein provide for location assisted beam refinement, such as in NTN deployments. For instance, implementations include switching from a wider beam to a narrower beam footprint for Msg2 transmission using location assisted framework. In implementations, a location assisted method is used to assist the network to switch from wider to narrow beam for Msg2 transmission when performing an initial access procedure. A mapping relation of a set of reference locations to the PRACH resources can be used to indicate to the network that which spatial filter for the narrow beam footprint within a wider SSB beam may be used for Msg2 transmission. One example of such a procedure includes the following: The UE upon detection of an SSB, can first compute its own location estimate, e.g., using GNSS (as in NTN GNSS capabilities to perform RACH procedure). The UE can then compare its own location estimate to the set of the reference locations that are part of received configuration for the received SSB. The UE can find the nearest reference location to its location estimates and depending on the method indicated in the configuration, the UE can use a mapping relation of the reference location to PRACH transmission to indicate the network about the nearest reference location. For instance, the UE can transmit RACH on the RO of the SSB of the nearest reference location. The NE (e.g., gNB) upon reception of preamble would know the reference location nearest to the UE and find the spatial filter for the coverage area of that reference location and would transmit Msg2 using spatial filter of the narrow beam.

In implementations, a PRACH configuration includes time and frequency resources for each of the set of reference locations corresponding to a wider beam (e.g., beam with common channel signaling, e.g., SSB), where these resources may correspond to one RO or multiple RO. For instance, a mapping can be included to distinguish which reference location is near to the UE location. The configuration includes at least some of the following parameters: (1) a set of reference locations for each wider beam footprint, where the reference location may be configured as latitude and longitudes or in position state vectors (i.e., in x, y, and z coordinates). The maximum number of reference locations for an SSB may be pre-defined. In one example, the maximum number may correspond to number of SSBs. (2) a mapping relationship of the reference locations of the SSB with time and frequency resources assigned for preamble transmission.

In implementations, the number of reference locations does not indicate to the UE the number of narrow beam footprints in the wider SSB beam footprint, e.g., there is no one to one correspondence between number of narrow beam footprints within a wide beam footprint and number of configured reference locations. The number of reference locations, for instance, may not correspond to the number of narrow beam footprints, and the number can assist the network in identifying the best spatial filter for narrow beam footprints by approximating the UE location in the wider beam footprint in an implicit way. Note that the narrow beams may still be transparent to the UE.

In implementations, the reference locations corresponding to each SSB can be defined in an SIB message (e.g., SIB19 dedicated for NTN UEs), and thus can implicitly indicate to the UE that PRACH transmission is based on a mapping relationship between reference locations and PRACH transmission. Alternatively or additionally, a dedicated field in the configuration can be used to indicate to the UE that the UE is to compare its location with the set of reference location and the PRACH transmission is based on a mapping relation.

In implementations, the mapping relation of reference locations to the frequency and time resources is based on one-to-one mapping of reference location with RACH occasions (ROs) of an SSB. In one example, each RO of the corresponding SSB can be implicitly used for one reference location where the mapping of reference locations to the ROs is in ascending order. For instance, if a UE is configured with 4 reference locations for each of the SSB and one SSB is associated with 4 RACH occasions (e.g., using the parameter ssb-perRACH-OccasionAndCB-PreamblesPerSSB=¼), then the first RO would be used for first reference location from the set of configured reference locations, second RO for second reference location, and so on. In one implementation, a mapping relation of reference locations to the time and frequency resources is also configured, thus defining which RO correspond to which reference location.

In implementations, the mapping relation of reference locations to the SSB is based on preamble distribution, where a set of preambles may be defined (or configured) for each of the reference locations within a wider beam footprint. For example, the total number of preambles may be divided into sets corresponding to the number of reference locations, and the UE can transmit on the assigned RO with one of the preambles from the set. Thus, the NE can know the best reference location based on the received preambles. In one example, the mapping of preamble to reference locations is based on ascending order where the first set corresponds to first reference location, second set to the second reference location, and so on. Alternatively or additionally, the network may also define in the configuration about the mapping relation of the preambles with the reference locations.

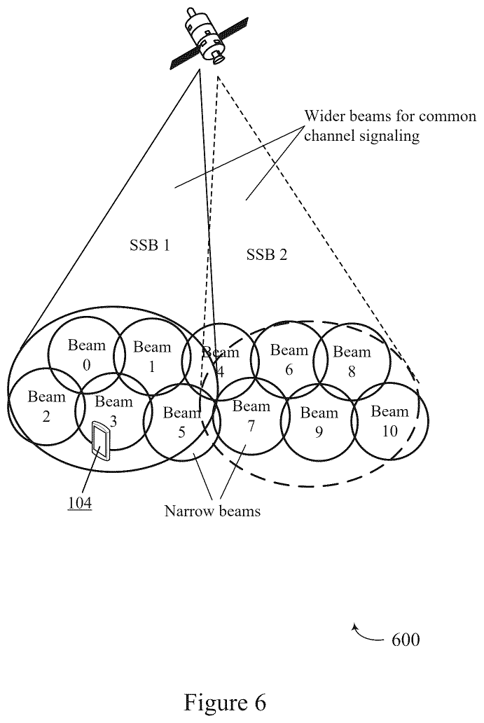

FIG. 6 illustrates a scenario 600 for reference locations for beams in accordance with aspects of the present disclosure. Note here, the narrow beams within the wider beam footprint are transparent to UE in most of the cases and shown here for the purpose of illustration. In implementations the UE may only get the information in the configuration about the number of reference locations which may or may not correspond to the narrow beam footprint. In implementations, the reference location may be chosen by the network as the approximate center of the narrow beam footprint. For example, as shown in the scenario 600, SSB 1 may accommodate 6 narrow beam footprints (beams 0-5) within the SSB 1 beam footprint. Further, SSB 2 may accommodate 6 narrow beam footprints (beams 4 and 6-10) within the SSB 2 beam footprint. In this configuration, a UE 104 can receive 6 reference locations for SSB 1 (e.g., reference locations for each of beams 0-5), where a mapping relation of the reference locations with the time frequency resources for RACH resources is also defined, e.g., based on implicit mapping of RO or preamble with reference location or based on an explicit indication of the mapping. The UE 104 can estimate its own position and calculate the best nearest reference location, e.g., reference location for beam 3. Using the defined mapping relation, the UE 104 can transmit preamble on the RO of the SSB, e.g., on RO of the reference location for beam 3 corresponding to SSB 1. Based on the RO or preamble, the network may know that beam 3 is best suited for UE and would transmit Msg2 on beam 3. In at least one implementation, the mapping relationship for a set of reference locations within a SSB can be broadcasted in NTN SIB as this may be common to all UEs and may be relevant to only NTN UEs.

In implementations, a UE can be located at a boundary between two reference locations, and the UE can indicate the two reference locations to the network. In one example, the indication can be in a form of two RACH occasions that are mapped to the two reference locations. In some scenarios, the UE is configured to indicate two reference locations only if a difference in a distance of the UE to a first of the two reference locations and a distance of the UE to a second of the two reference locations is no larger than a threshold. The threshold can be network configured or fixed. In one example, when the reference locations are uniformly distributed, a single value of the distance is configured along with reference locations configuration, where the distance threshold value may be common for all SSBs. In one example, a distance threshold value for each of the SSB is separately configured. In another example, the distance threshold is coupled with two reference locations and multiple distance values related to different reference locations are configured.

Implementations also provide for switching from wider to narrow beam footprint in connected mode using location assisted framework. In implementations, when in connected mode, the location assisted method can be used to assist the network to switch from wider beam footprint (e.g., SSB) that carry common channel signaling information to narrow beam footprint for other channels, e.g., data transmission. The UE can receive an explicit or implicit indication when performing initial access whether the PRACH transmission based on reference location mapping is valid for connected mode. The switching from wider beam footprint to narrow beam footprint may also be needed in connected mode such as in cases of earth moving cell, where the coverage area of the beams is changing with the satellite thus a fast beam refinement procedure may be needed.

In addition to the parameters discussed above for idle mode UEs, the configuration to apply location assisted PRACH transmission may include at least some of the following parameters: (1) An enabler indication that indicates whether to apply a location assisted RACH procedure for every SSB detection period, e.g., coupled with SSB periodicity. (2) A validity duration for the reference location, e.g., after the validity duration new reference locations may be needed. The validity duration may indicate to UE that the reference locations are valid for the next detected SSB or not. For example, a UE can perform an initial access procedure where an SSB periodicity is 20 ms and a validity duration for the reference locations is 40 ms. Where the location assisted RACH procedure is enabled, the UE can then use the same reference location when SSB is detected in 20 ms (even if not configured with a set of reference location) and may only use the reference location after 40 ms. (3) A time repetition indication, e.g., periodic, aperiodic, or semi persistent indicating when to use the location assisted RACH procedure. The network may set this indication based on type of cells, e.g., earth-moving cells or earth fixed cell, or based on satellite trajectory and altitude.

In implementations, the location assisted method includes switching from wider beam footprint to narrow beam footprint using a set of reference locations in the wider beam footprint and an implicit indication from the UE about the nearest reference location. Further, the location assisted method can be based on other reference signals such as SRS, where the mapping of a set of reference locations to the uplink reference signal (e.g., SRS resources) is configured during or after the initial access procedure and UE is expected to transmit at least one mapped reference signal depending on the choice of the nearest reference location. Transmission of the reference signal may be configured at periodicity (e.g., a set time interval) (e.g., after a gap of some slots) or may be coupled with SSB (e.g., whenever an SSB is received), and the UE can transmit SRS on the configured resource of the reference location. The network may continue monitoring the SRS resources based on a configured periodicity. The reference signal configuration can include at least one of the following information: (1) A set of reference locations corresponding to each wider beam containing the common channel signaling (e.g., for each SSB). (2) A mapping relationship e.g., a mapping mechanism of reference locations with the assigned uplink reference signal resources (e.g., SRS resources) with a predefined mapping pattern (e.g., one-to-one mapping) or a mapping relation defined in the configuration. (3) Triggering indication, e.g., uplink reference signal transmission with SSB detection or at specific interval. (4) Uplink reference signal periodicity, e.g., signal is aperiodic, periodic, semi-persistent. (5) A distance threshold to indicate multiple uplink reference signal transmissions in case a UE is at the boundary of two reference signals.

In implementations, a UE in connected mode can be assigned with a set of reference locations corresponding to the wider beam footprint signals (e.g., SSB), where a mapping of SSB to reference signal is configured. The UE upon detection of the wider beam (e.g., SSB) can transmit a UCI where the UCI can contain parameters for indicating the detected SSB and bits corresponding to one of the index of the reference locations nearest to the UE location. For example, if four reference locations are assigned for each SSB and reference location 3 is the nearest to the UE, then the UE can transmit two bits corresponding to the third reference location in the set of four, and the UE can also include SSB index.

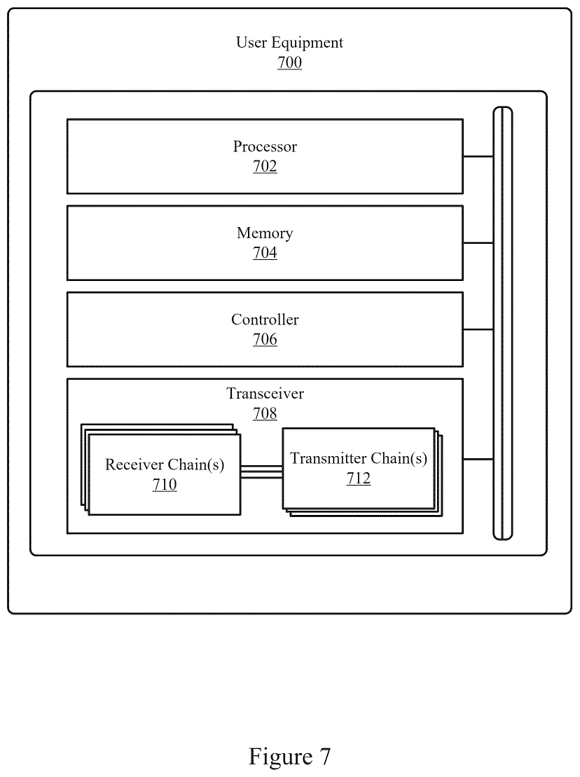

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to or operable to support a means for receiving a first downlink beam; transmitting at least one uplink signal based at least in part on the first downlink beam, the at least one uplink signal mapped to a reference location; and receiving a second downlink beam, wherein one or more spatial characteristics of the second downlink beam are based at least in part on the first downlink beam and the reference location associated with the at least one uplink signal.

Additionally, the UE 700 may be configured to support any one or combination of where the at least one uplink signal corresponds to a PRACH; the at least one uplink signal is part of a set of uplink signals, and each uplink signal of the set of uplink signals is mapped to a different respective reference location; the second downlink beam includes one or more of DMRS for PDSCH, TRS, or CSI-RS; one or more of a coverage area, a beam width, or a beam footprint associated with the first downlink beam is larger than one or more of a coverage area, a beam width, or a beam footprint associated with the second downlink beam; the at least one uplink signal includes a PRACH based on a mapping relation of a set of reference locations corresponding to the first downlink beam according to a RACH procedure, and wherein the PRACH is transmitted over a RO of a corresponding SSB; the mapping relation of the set of reference locations to ROs of an SSB index is based at least in part on one-to-one mapping of the set of reference locations to the ROs in an ascending order of a configuration.

Additionally, the UE 700 may be configured to support any one or combination of where the mapping relation of the set of reference locations to ROs of an SSB index is based at least in part on a set of distinct preambles corresponding to each reference location of the set of reference locations; In some aspects, the techniques described herein relate to a method, further including receiving a configuration for the at least one uplink signal, wherein the configuration includes an indication to transmit PRACH based on a mapping of reference locations to ROs of an SSB in a connected state; a configuration for the at least one uplink signal includes a validity duration of the set of reference locations; the at least one uplink signal includes two uplink signals each associated with a different reference location; further including transmitting the two uplink signals based at least in part on a difference in a distance of the UE from a first reference location and distance of the UE from a second reference location satisfies a threshold.

Additionally, the UE 700 may be configured to support any one or combination of transmitting the at least one uplink signal using a spatial filter associated with the first downlink beam; further including receiving NTN SIB including mapping information for a set of reference locations with at least one SSB; a set of reference locations corresponding to the first downlink beam are configured as a set of latitude and longitude; a set of reference locations corresponding to the first downlink beam are configured as a set of position state vectors; the at least one uplink signal includes a SRS based on a mapping relation of a set of reference locations corresponding to the first downlink beam, and wherein the SRS is transmitted over time and frequency resources corresponding to the set of reference locations of an SSB; information about at least one reference location from a set of configured reference locations of the first downlink beam is transmitted as part of UCI.

Additionally, or alternatively, the UE 700 may support at least one memory (e.g., the memory 704) and at least one processor (e.g., the processor 702) coupled with the at least one memory and configured to cause the UE to receive a first downlink beam; transmit at least one uplink signal based at least in part on the first downlink beam, the at least one uplink signal mapped to a reference location; and receive a second downlink beam, wherein one or more spatial characteristics of the second downlink beam are based at least in part on the first downlink beam and the reference location associated with the at least one uplink signal.

Additionally, the UE 700 may be configured to support any one or combination of where the at least one uplink signal corresponds to a PRACH; the at least one uplink signal is part of a set of uplink signals, and each uplink signal of the set of uplink signals is mapped to a different respective reference location; the second downlink beam includes one or more of DMRS for PDSCH, TRS, or CSI-RS; one or more of a coverage area, a beam width, or a beam footprint associated with the first downlink beam is larger than one or more of a coverage area, a beam width, or a beam footprint associated with the second downlink beam; the at least one uplink signal includes a PRACH based on a mapping relation of a set of reference locations corresponding to the first downlink beam according to a RACH procedure, and wherein the PRACH is transmitted over a RO of a corresponding SSB; the mapping relation of the set of reference locations to ROs of an SSB index is based at least in part on one-to-one mapping of the set of reference locations to the ROs in an ascending order of a configuration.

Additionally, the UE 700 may be configured to support any one or combination of where the mapping relation of the set of reference locations to ROs of an SSB index is based at least in part on a set of distinct preambles corresponding to each reference location of the set of reference locations; the at least one processor is configured to cause the UE to receive a configuration for the uplink signal, wherein the configuration includes an indication to transmit PRACH based on a mapping of reference locations to ROs of an SSB in a connected state; the configuration for the uplink signal includes a validity duration of the reference locations; the at least one uplink signal includes two uplink signals each associated with a different reference location; the at least one processor is configured to cause the UE to transmit the two uplink signals based at least in part on a difference in a distance of the UE from a first reference location and distance of the UE from a second reference location satisfies a threshold; the at least one processor is configured to cause the UE to transmit the at least one uplink signal using a spatial filter associated with the first downlink beam.

Additionally, the UE 700 may be configured to support any one or combination of where the at least one processor is configured to cause the UE to receive NTN SIB including mapping information for a set of reference locations with at least one SSB; the reference locations corresponding to the first downlink beam are configured as a set of latitude and longitude; the reference locations corresponding to the first downlink beam are configured as a set of position state vectors; the at least one uplink signal includes a SRS based on a mapping relation of a set of reference locations corresponding to the first downlink beam, and wherein the SRS is transmitted over time and frequency resources corresponding to the reference locations of an SSB; information about at least one reference location from a set of configured reference locations of the first downlink beam is transmitted as part of UCI.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

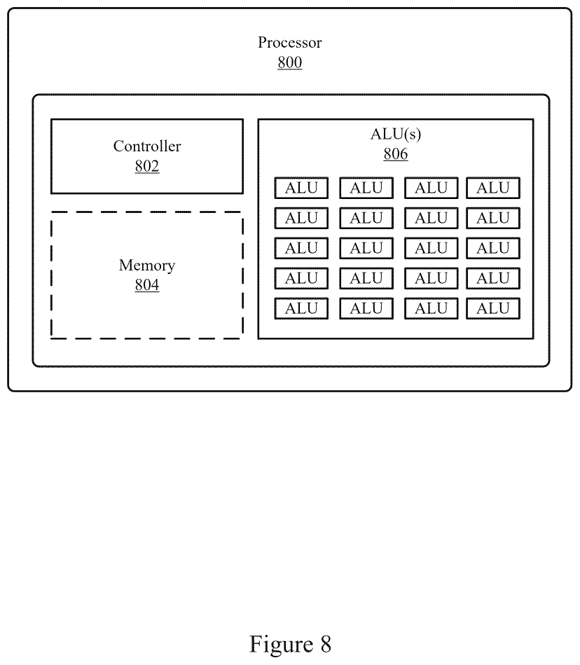

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to or operable to support at least one controller (e.g., the controller 802) coupled with at least one memory (e.g., the memory 804) and configured to cause the processor to receive a first downlink beam; transmit at least one uplink signal based at least in part on the first downlink beam, the at least one uplink signal mapped to a reference location; and receive a second downlink beam, wherein one or more spatial characteristics of the second downlink beam are based at least in part on the first downlink beam and the reference location associated with the at least one uplink signal.

Additionally, the processor 800 may be configured to or operable to support any one or combination of where the at least one uplink signal corresponds to a PRACH; the at least one uplink signal is part of a set of uplink signals, and each uplink signal of the set of uplink signals is mapped to a different respective reference location; the second downlink beam includes one or more of DMRS for PDSCH, TRS, or CSI-RS; one or more of a coverage area, a beam width, or a beam footprint associated with the first downlink beam is larger than one or more of a coverage area, a beam width, or a beam footprint associated with the second downlink beam; the at least one uplink signal includes a PRACH based on a mapping relation of a set of reference locations corresponding to the first downlink beam according to a RACH procedure, and wherein the PRACH is transmitted over a RO of a corresponding SSB; the mapping relation of the set of reference locations to ROs of an SSB index is based at least in part on one-to-one mapping of the set of reference locations to the ROs in an ascending order of a configuration.

Additionally, the processor 800 may be configured to or operable to support any one or combination of where the mapping relation of the set of reference locations to ROs of an SSB index is based at least in part on a set of distinct preambles corresponding to each reference location of the set of reference locations; the at least one controller is configured to cause the processor to receive a configuration for the uplink signal, wherein the configuration includes an indication to transmit PRACH based on a mapping of reference locations to ROs of an SSB in a connected state; the configuration for the uplink signal includes a validity duration of the set of reference locations; the at least one uplink signal includes two uplink signals each associated with a different reference location; the at least one controller is configured to cause the processor to transmit the two uplink signals based at least in part on a difference in a distance of a UE from a first reference location and distance of the UE from a second reference location satisfies a threshold; the at least one controller is configured to cause the processor to transmit the at least one uplink signal using a spatial filter associated with the first downlink beam.

Additionally, the processor 800 may be configured to or operable to support any one or combination of where the at least one controller is configured to cause the processor to receive NTN SIB including mapping information for a set of reference locations with at least one SSB; the set of reference locations corresponding to the first downlink beam are configured as a set of latitude and longitude; the set of reference locations corresponding to the first downlink beam are configured as a set of position state vectors; the at least one uplink signal includes a SRS based on a mapping relation of a set of reference locations corresponding to the first downlink beam, and wherein the SRS is transmitted over time and frequency resources corresponding to the set of reference locations of an SSB; information about at least one reference location from a set of configured reference locations of the first downlink beam is transmitted as part of UCI.

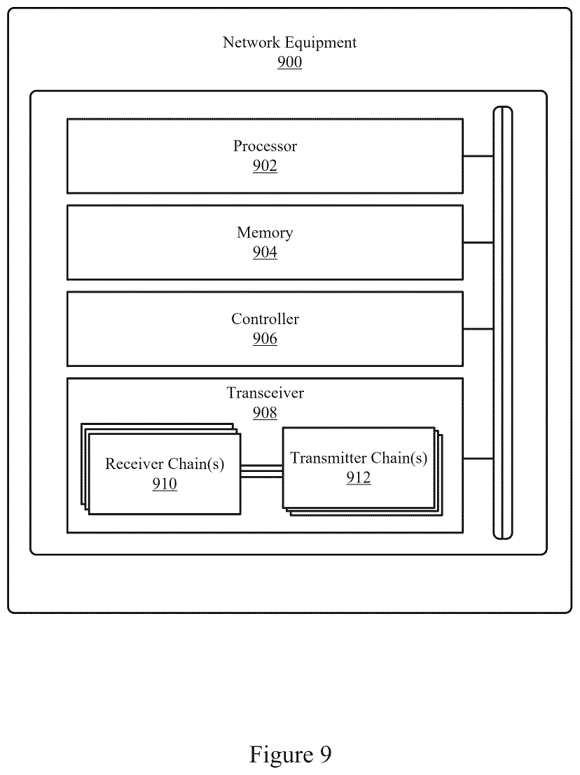

FIG. 9 illustrates an example of a NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to or operable to support a means for transmitting a first downlink beam; receiving at least one uplink signal based at least in part on the first downlink beam, the at least one uplink signal mapped to a reference location; and transmitting a second downlink beam, wherein one or more spatial characteristics of the second downlink beam are based at least in part on the first downlink beam and the reference location associated with the at least one uplink signal.

Additionally, the NE 900 may be configured to or operable to support any one or combination of where the at least one uplink signal includes PRACH; the at least one uplink signal is part of a set of uplink signals, and each uplink signal of the set of uplink signals is mapped to a different respective reference location; the second downlink beam includes one or more of DMRS for PDSCH, TRS, or CSI-RS; one or more of a coverage area, a beam width, or a beam footprint associated with the first downlink beam is larger than one or more of a coverage area, a beam width, or a beam footprint associated with the second downlink beam; the at least one uplink signal includes a PRACH based on a message 2 transmission according to a RACH procedure, and wherein the PRACH is received over a RACH occasion of a corresponding SSB; the at least one uplink signal includes two uplink signals each associated with a different reference location.

Additionally, or alternatively, the NE 900 may support at least one memory (e.g., the memory 904) and at least one processor (e.g., the processor 902) coupled with the at least one memory and configured to cause the NE to transmit a first downlink beam; receive at least one uplink signal based at least in part on the first downlink beam, the at least one uplink signal mapped to a reference location; and transmit a second downlink beam, wherein one or more spatial characteristics of the second downlink beam are based at least in part on the first downlink beam and the reference location associated with the at least one uplink signal.

Additionally, the NE 900 may be configured to support any one or combination of where the at least one uplink signal includes PRACH; the at least one uplink signal is part of a set of uplink signals, and each uplink signal of the set of uplink signals is mapped to a different respective reference location; the second downlink beam includes one or more of DMRS for PDSCH, TRS, or CSI-RS; one or more of a coverage area, a beam width, or a beam footprint associated with the first downlink beam is larger than one or more of a coverage area, a beam width, or a beam footprint associated with the second downlink beam; the at least one uplink signal includes a PRACH based on a message 2 transmission according to a RACH procedure, and wherein the PRACH is received over a RACH occasion of a corresponding SSB; the at least one uplink signal includes two uplink signals each associated with a different reference location.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

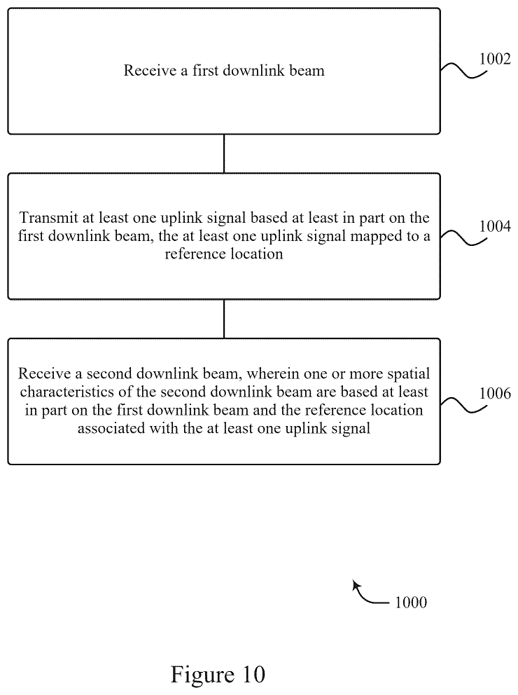

FIG. 10 illustrates a flowchart of a method 1000 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1002, the method may include receiving a first downlink beam. The operations of 1002 may be performed in accordance with examples as described herein. In some implementations, aspects of the operations of 1002 may be performed by a UE as described with reference to FIG. 7.

At 1004, the method may include transmitting at least one uplink signal based at least in part on the first downlink beam, the at least one uplink signal mapped to a reference location. The operations of 1004 may be performed in accordance with examples as described herein. In some implementations, aspects of the operations of 1004 may be performed by a UE as described with reference to FIG. 7.

At 1006, the method may include receiving a second downlink beam, wherein one or more spatial characteristics of the second downlink beam are based at least in part on the first downlink beam and the reference location associated with the at least one uplink signal. The operations of 1006 may be performed in accordance with examples as described herein. In some implementations, aspects of the operations of 1006 may be performed a UE as described with reference to FIG. 7.

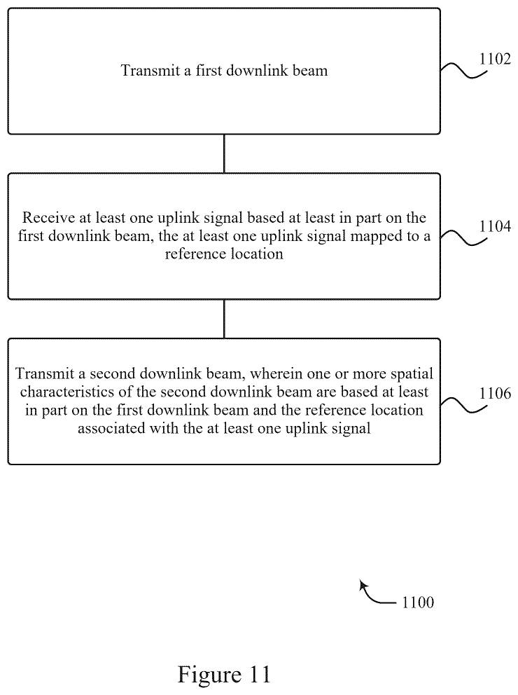

FIG. 11 illustrates a flowchart of a method 1100 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include transmitting a first downlink beam. The operations of 1102 may be performed in accordance with examples as described herein. In some implementations, aspects of the operations of 1102 may be performed by a NE as described with reference to FIG. 9.

At 1104, the method may include receiving at least one uplink signal based at least in part on the first downlink beam, the at least one uplink signal mapped to a reference location. The operations of 1104 may be performed in accordance with examples as described herein. In some implementations, aspects of the operations of 1104 may be performed by a NE as described with reference to FIG. 9.

At 1106, the method may include transmitting a second downlink beam, wherein one or more spatial characteristics of the second downlink beam are based at least in part on the first downlink beam and the reference location associated with the at least one uplink signal. The operations of 1106 may be performed in accordance with examples as described herein. In some implementations, aspects of the operations of 1106 may be performed a NE as described with reference to FIG. 9.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a first downlink beam;
transmit at least one uplink signal based at least in part on the first downlink beam, the at least one uplink signal mapped to a reference location; and
receive a second downlink beam, wherein one or more spatial characteristics of the second downlink beam are based at least in part on the first downlink beam and the reference location associated with the at least one uplink signal.

2. The UE of claim 1, wherein the at least one uplink signal corresponds to a physical random access channel (PRACH).

3. The UE of claim 1, wherein the at least one uplink signal is part of a set of uplink signals, and each uplink signal of the set of uplink signals is mapped to a different respective reference location.

4. The UE of claim 1, wherein the second downlink beam includes one or more of demodulation reference signal (DMRS) for physical downlink shared channel (PDSCH), tracking reference signal (TRS), or channel state information reference signal (CSI-RS).

5. The UE of claim 1, wherein one or more of a coverage area, a beam width, or a beam footprint associated with the first downlink beam is larger than one or more of a coverage area, a beam width, or a beam footprint associated with the second downlink beam.

6. The UE of claim 1, wherein the at least one uplink signal comprises a physical random access channel (PRACH) based on a mapping relation of a set of reference locations corresponding to the first downlink beam according to a random access channel (RACH) procedure, and wherein the PRACH is transmitted over a RACH occasion (RO) of a corresponding synchronization signal block (SSB).

7. The UE of claim 6, wherein the mapping relation of the set of reference locations to ROs of an SSB index is based at least in part on one-to-one mapping of the set of reference locations to the ROs in an ascending order of a configuration.

8. The UE of claim 6, wherein the mapping relation of the set of reference locations to ROs of an SSB index is based at least in part on a set of distinct preambles corresponding to each reference location of the set of reference locations.

9. The UE of claim 6, wherein the at least one processor is configured to cause the UE to receive a configuration for the at least one uplink signal, wherein the configuration comprises an indication to transmit PRACH based on a mapping of reference locations to ROs of an SSB in a connected state.

10. The UE of claim 6, wherein a configuration for the at least one uplink signal includes a validity duration of the set of reference locations.

11. The UE of claim 1, wherein the at least one uplink signal comprises two uplink signals each associated with a different reference location.

12. The UE of claim 11, wherein the at least one processor is configured to cause the UE to transmit the two uplink signals based at least in part on a difference in a distance of the UE from a first reference location and distance of the UE from a second reference location satisfies a threshold.

13. The UE of claim 1, wherein the at least one processor is configured to cause the UE to transmit the at least one uplink signal using a spatial filter associated with the first downlink beam.

14. The UE of claim 1, wherein reference locations corresponding to the first downlink beam are configured as a set of latitude and longitude.

15. The UE of claim 1, wherein reference locations corresponding to the first downlink beam are configured as a set of position state vectors.

16. The UE of claim 1, wherein the at least one uplink signal comprises a sounding reference signal (SRS) based on a mapping relation of a set of reference locations corresponding to the first downlink beam, and wherein the SRS is transmitted over time and frequency resources corresponding to reference locations of an SSB.

17. The UE of claim 1, wherein information about at least one reference location from a set of configured reference locations of the first downlink beam is transmitted as part of uplink control information (UCI).

18. A processor for wireless communication, comprising:
at least one controller coupled with at least one memory and configured to cause the processor to:
receive a first downlink beam;
transmit at least one uplink signal based at least in part on the first downlink beam, the at least one uplink signal mapped to a reference location; and
receive a second downlink beam, wherein one or more spatial characteristics of the second downlink beam are based at least in part on the first downlink beam and the reference location associated with the at least one uplink signal.

19. A method performed by a user equipment (UE), the method comprising:
receiving a first downlink beam;
transmitting at least one uplink signal based at least in part on the first downlink beam, the at least one uplink signal mapped to a reference location; and
receiving a second downlink beam, wherein one or more spatial characteristics of the second downlink beam are based at least in part on the first downlink beam and the reference location associated with the at least one uplink signal.

20. A network equipment for wireless communication, comprising:
at least one memory; and
at least one processor coupled with the at least one memory and configured to cause the network equipment to:
transmit a first downlink beam;
receive at least one uplink signal based at least in part on the first downlink beam, the at least one uplink signal mapped to a reference location; and
transmit a second downlink beam, wherein one or more spatial characteristics of the second downlink beam are based at least in part on the first downlink beam and the reference location associated with the at least one uplink signal.
